(19) United States
(12) Patent Application Publication
(10) Pub. No.: US 2026/0065007 A1
(43) Pub. Date: Mar. 5, 2026

(54) CELL FREE AND MULTI-TRP WIRELESS NETWORKS

(71) Applicant: Oswego Technologies LLC, columbus, NJ (US)

(72) Inventors: Raziq Yaqub, Lumberton, NJ (US); Brian Gordaychik, Columbus, NJ (US)

(21) Appl. No.: 19/378,861

(22) Filed: Nov. 4, 2025

Related U.S. Application Data
(63) Continuation of application No. 19/173,874, filed on Apr. 9, 2025.
(60) Provisional application No. 63/658,823, filed on Jun. 11, 2024.
(60) Provisional application No. 63/676,366, filed on Jul. 27, 2024.
(60) Provisional application No. 63/718,826, filed on Nov. 11, 2024.

(51) Int. Cl. G06K 19/07; G06K 7/00; G06K 7/10; H04L 27/26

(52) U.S. Cl. CPC G06K 19/0723; G06K 7/0008; G06K 7/10019; H04L 27/2607

(57) ABSTRACT

Provided herein is a method performed by a UE configured to operate in a m-TRP or cell free network. The method comprises receiving a first beam of a first set of wide SSB beams transmitted by a first gNB and receiving a second beam of a second set of narrow SSB beams transmitted by a second gNB which is different from the first gNB. The UE may predict, from the first beam and/or the second beam, a beam which is not transmitted by either one of the first gNB or the second gNB. The UE may then perform random access by transmitting a random access preamble based on the predicted beam.

### CROSS REFERENCE TO RELATED APPLICATIONS

This application is a continuation of U.S. patent application Ser. No. 19/173,874 filed on Apr. 9, 2025 which claims the benefit of U.S. Provisional Patent Application Nos. 63/658,823 filed on Jun. 11, 2024, 63/676,366 filed on Jul. 27, 2024 and 63/718,826 filed on Nov. 11, 2024, the contents of each of where are incorporated by reference herein.

### SUMMARY

Provided herein is a method performed by a user equipment (UE) configured to operate in a multi-transmission reception point (TRP) or cell free network. The method comprises receiving a first beam of a first set of wide synchronization signal block (SSB) beams transmitted by a first gNB and receiving a second beam of a second set of narrow SSB beams transmitted by a second gNB which is different from the first gNB. The UE may predict, from the first beam and/or the second beam, a beam which is not transmitted by either one of the first gNB or the second gNB. The UE may then perform random access by transmitting a random access preamble based on the predicted beam. Information indicating that Discrete Fourier Transform (DFT) spreading Orthogonal Frequency-Division Multiplexing (DFT-s-OFDM) is to be used for uplink communication may be received from one of the first gNB or the second gNB. When the UE receives control information that triggers an uplink transmission, the UE may determine a rank for the uplink transmission corresponding to a plurality of spatial streams. The UE may transmit data on a PUSCH using DFT-s-ODFM in accordance with the determined rank.

### BRIEF DESCRIPTION OF THE DRAWINGS

FIG. 1 is an illustration of synchronization signal block (SSB) designs;

FIG. 2 illustrates a multi-TRP embodiment wherein TRPs vary a beam width for transmission of SSB; and

FIG. 3 is a multi-TRP illustration of a wireless device receiving transmissions of multiple TRPs simultaneously.

### DETAILED DESCRIPTION OF THE DRAWINGS

As a preliminary matter, it will be readily understood by those persons skilled in the art that the present embodiments are susceptible of broad utility and application. Many methods, embodiments, and adaptations of the present application other than those herein described as well as many variations, modifications, and equivalent arrangements, will be apparent from or reasonably suggested by the substance or scope of the various embodiments of the present application.

In cell free and multi-TRP embodiments, periodic signaling, including system information block 1 (SIB1) transmissions may be reduced in size by certain base stations but not others. Some base stations may transmit information about the SIB, SIB size, etc. to another base station.

Base stations and other stationary ground units may be woken up along with satellite cells. In embodiments, a UE may transmit a wake up signal as a PRACH signal or during or after being in connected mode. The wake up signal may indicate a cell that the UE desires to wake up. Alternatively, or in combination, the UE may indicate a need for the base station to wake up another cell by providing information about the UE situation (for example, the UE may instruct wake up inherently by providing a buffer status). Alternatively on in combination, the UE may wake up one device via a capability indication to another device. The device receiving the capability device may make a determination based on a number of users in a cell, a number of devices having a certain capability, etc., a frequency range, a uplink/downlink mode, number of beams used (or which beams may be used) and based on such information may wake up another cell. A UE may provide a base station with conditional information for indicating whether to wake up another cell.

In embodiments, a UE may not know in advance that it is waking up a cell and may perform a normal PRACH transmission without specifically instructing a wake up signal. For example, a PRACH parameter for wake up may be included in a message format, such parameter may not be set by a transmitting UE, and a cell may be woken up regardless. The UE may wake up multiple cells based on transmitting a wake up signal (for example using on off keying OOK or another modulation type or protocol). In embodiments, the number of cells woken up may be based on a beam, frequency, time, data amount, amount of data waiting for the UE at the network, an expected uplink or downlink data quantity, a threshold value or the like.

When a UE transmits PRACH wake up signal, it may immediately monitor for SIB1 based on an RNTI according to a base station which is not of the one being woken up. An on demand SIB1 may not be coded with a unique RNTI, but rather may be coded according to a default RNTI assigned to on demand SIB1. A random access response may include SIB1 parameters, may include an RNTI for receiving SIB1, may include information on timing, base station identity, cell, beam, or the like for receiving SIB1. Wake up cell parameters may be provided to UEs other network entities disclosed herein via DCI or RRC signaling.

Wireless systems may have flexible antenna arrays, wherein antennas are moveable (flexible) according to the channel conditions (e.g. fading, diversity, noise, interference, etc.). receive side devices may determine signal to interference and noise differences on spatial streams used on different frequencies during distinguished time periods. Flexible antennas may be used to form beams that are atypical in nature, for example, rainbow shaped, parabolic, etc. by changing a wavelength of a beam and using modulation techniques including pulse amplitude modulation (PAM), on off keying and adaptive discrete multitone (DMT) in which frames may include a plurality of types of modulation schemes. Aside from changing a beam, a transmitter may change polarization. Certain systems may employ DCI formats which signal parameters for devices which are capable of adjusting parameters according to environmental conditions, locations and obstacles. DCI formats may be based on, may schedule or may coincide with periodicity, offset and duration conditions. In embodiments, DCI, RRC or MAC layer signaling may indicate for a UE to turn on or off a certain antenna or set of antennas. Such DCI, RRC or MAC layer signaling may comprise or consist of any parameters disclosed herein. If indicated as a set of antennas, a single bit or bit array may indicate an array of antennas to toggle on or off. Antenna panels or elements within a panel may be toggled off. For example, the antenna may be powered off, or the processing components coupled to an antenna or antenna element may be toggled on/off. DCI, RRC or MAC layer signaling may indicate position in absolute or relative terms via an X, Y or Z direction. Base stations and UEs may determine transmission orthogonality in time/frequency (using, for example, OFDMA or filter bank multicarrier (FBMC) modulation) and may use the flexible antennas to transmit on overlapping time/frequency resources with another UE. UEs may signal to one another or to BSs, CSI information (e.g. full state channel feedback, eigenvector based, or a combination thereof, which may or may not incorporate a data transmission in a same frame) based on a current antenna position as compared to a change in antenna position based on information received via DCI, RRC or MAC layer signaling. CSI may be configured/indicated with an association identifier that is packaged and may be associated with other signals herein. Various CSI length and feedback bitlength may be employed using signaling via RRC or DCI to indicate length. In embodiments, communication may begin in an OFDMA and switch to a non-orthogonal multiple access scheme based on a number of free antennas available at wireless devices, for example, base stations, relays and UEs.

In embodiments, the system may also revert to a non-timing aligned multiple access scheme, where transmissions are neither aligned in frequency nor in time, again, based on a threshold number of extra available antennas at devices. Indication to switch to a different type of access scheme may be depending on a network topology, for example, cell based or cell free, and may be based on calculated extra antennas available at each wireless device. A combination of cell based and cell free may be used in embodiments where channels or carriers are aggregated. As channel rank increases, flexibility in access scheme may be employed. Devices may share such information with one another via DCI, MAC or RRC layer signaling. Orthogonality may apply to certain devices and not others, for example, certain release versions may ensure tight channel and time orthogonality, while newer upgraded devices may not have to rely on the same so long as the base station is of higher capability.

For example, frequency domain allocations may be subsections of a 20 mhz allocation, for example in 2.5 mhz, 3 mhz, 5 mhz, 10 mhz allocations, etc. They may also be shorter in time duration. For example, multiple different transmissions may occur in an allocation. Trigger frames may provide an allocation in terms of polarity and may thus provide polarization information for use by downlink and uplink frames that follow the trigger frame. Based on certain information in the trigger frame, and a rank and CSI developed at a receiver, a frame to follow may be transmitted on one or more spatial streams that are separated based on polarization, frequency, beam, or the like.

Determining how well the sensing and communication overlap is working can be determined similar to a rank determination of earlier releases, e.g. the UEs may report a SNR or delta SNR according to the decline in channel quality based on the increase in sensing use. Certain parameters like doppler estimation parameters, SNR reductions, etc. may be used for making the determination. For instance, if sensing transmissions increase, they may have little to no affect on SNR for certain users and more of an affect on SNR for other certain users. The transmitter may take this into consideration via receiving noise related information via RRC signaling.

BSs may indicate to a UE via DCI, RRC or MAC layer signaling to control software aspects of the UE and change structure, e.g. shape, position, angle, location so that frequency and pattern can be altered. This way, a UE may adjust a receive frequency or by adjusting antenna positions. In some aspects, a UE or BS may convey transmission parameters via the change in antenna position. For example, by turning an antenna element off, the BS or UE may convey a bit change and thus communicate a parameter. BY doing this while communication, the BS or UE may inherently modulate data differently (for example, by changing phase, amplitude or frequency) and thus provide information across the channel.

Certain UEs or BSs having compliant movable antennas may control antenna movement automatically with or without network feedback or information simply by measuring the signal pre and post movement. Battery powered devices with movable antennas may report battery power and/or capacity and may be signaled according to the battery charge, power or capacity.

With parasitic antennas, UEs/BS may report capability in terms of a device type: for example, robot, movable base station, assembly line device, rotation base, etc. So these types of devices may be controlled not only according to their antennas, but also in terms of the movement of the device. UEs/BS may be capable of multiple sets of antenna panels and elements such that they implement more than one type of panel/antenna. Devices may report whether antennas are passive/active.

Adaptive modulation techniques may be employed by wired and wireless devices. Transmitters may actively manipulate inherent noise in a wireless system, for example, channel delay and doppler spread, in an effort to communicate data more quickly and securely. Devices may use OFDM in combination with other modulation techniques, for example, by using OFDM in environments with certain noise constraints and other OFDM or non-OFDM schemes in other environments, for example, based on a noise threshold, synchronization threshold or other threshold(s). Alternatives to OFDM include orthogonal time frequency space (OTFS), orthogonal delay-Doppler modulation (ODDM), vector OFDM and delay doppler alignment modulation (DDAM). Different modulation techniques may be employed depending on the mobile device speed and likelihood of switching cells. A modulation technique may be configured based on a number of devices in a range operating at a certain capability or above. In some embodiments, ofdm and otfs may be used simultaneously, with different cells and/or different beams supporting different modulation techniques. Beams which may support trains or UAVs, for example, may use OTFS while slower moving UEs, e.g. pedestrian level beams or beams within cities may use ofdm or ofdma. UAVs may form swarms of which some UAVs may be controlling UAVs and others may be controlled by the controlling UAVs.

In some embodiments, a UE or BS may simultaneously alter or modulate the amplitude, phase and/or frequency of an incident beam in order to perform beam steering of a varying beam thickness, for example, creating parabolic type beams having a bending trajectory. Alternatively, or in combination, a phase plate may be used to create similar shapes. In embodiments, a UE and a base station may report a capability to support parabolic beam shapes. The UE may send a capability indicator with other capability information to the network. A BS may indicate support via SIB or may do so implicitly by sending certain parabolic beam shapes during synchronization signaling, for example, during a synchronization signal block (SSB) which is indexed per beam and may or may not be indexed according to a common clock that may be known by both a UE and base station (or any other device thereof). In embodiments, the BS may perform standard SSB by rotating beams and may convey timestamping information using beam changing, frequency changing or time changing transmissions. 802.11 type stations may apply similar, yet not identical beam steering and forming procedures as are disclosed herein. 3^{rd} party devices may provide clock signaling information.

Synchronization may be supplemented by parabolic SSB interleaving. For example, an SSB pattern may comprise beams having a straight-line trajectory interleaved with beams of a parabolic nature. For example, in a pattern fashion. In embodiments, one or more straight-line beams may follow or precede a parabolic beam of a same or different frequency, for example, a higher frequency beam. In such embodiments or others, straight line trajectory beams may be used in scenarios where location specific beam knowledge is had by the transmitter and parabolic beam types are used in certain scenarios in which it is not. SSBs may be adapted or changes in frequency, space, time, content or otherwise, based on DCI or another signal provided for herein. Transmitting devices may be vision aided, for example, via RF means, and may form beams and/or beam patterns based on observed obstacles alone or in combination with LIDAR and video cameras. Based on measurements taken by a bases station, for example, via LiDAR, RF sensing or video cameras, the base station may transmit information to a UE or other wireless device requesting, via RRC, the wireless device to provide measurements taken from the other side of the channel, for example, other RF sensing measurements to confirm obstacles, etc. The bs may provide assistance data to the UE, for example, a list of beams to perform sensing, a direction angle or otherwise to perform vision analysis, a periodicity for transmitting responses, location information indicative of when to begin measurements and location information indicative of when to stop taking measurements. The gnb or other base station may provide information to a group of UEs, for example, via RRC or via DCI with information on timing, a resource grant for uplink transmission, etc. The gNB instead of transmitting such information to a UE may send the information and request to a mobile node which is not a user node, for example, an RIS, a relay, or the like. In the case of an RIS or other device, RRC parameters may specify information for the UE or other wireless device to calculate a 3d position of the ue or another UE.

There may also be specification of parameters for calculating a one, two or three dimensional position of a base station or RIS (depending on whether the device is active or inactive). If active, a UE or other device may be provided with information on modulation, amplification and phase modification via RRC. A UE may be informed as to whether a RIS or other device is movable is certain directions, for example, vertically in altitude, horizontally or rotated along with movement. The UE may receive altitude and other information via SSB, SIB, etc for example, in only certain beam indices which are transmitted with that information. For example, in an FDD system, SSB indices at certain beams only may provide information used by the receiver to derive uplink or downlink beam selection. For example, the BS may indicate beams for use in a particular location by transmitting such information only when transmitting beams in a direction towards that location.

Thus, base stations and other SSB transmitting stations may vary information in each beam used for transmitting SSB. Base stations and other moving stations may negotiate parabolic or other straight/non-straight patterns for SSB or other data transmission. It may be that each station transmits SSBs of signals thereof in a comb fashion, for example, comb-x, x being a multiple of any number greater than 1. The comb may be an offset such as comb-x+an offset which increases according to frequency, time or beam. Offset may be based on a parameter chosen from a list, based on prime numbers, a number of symbols, a number of SSB time indices etc. Demodulation reference signals may be placed along the frequency domain in any time interval to convey angle of arrival/departure, delay, phase, doppler shift, amplitude or time. For example, DMRS may be transmitted in a comb manner at a single SSB time index, at each one of a plurality of SSB time indices or in all SSB time indices. There may be multiple combs in an SSB, either within the synchronization signals, e.g. the PSS and SSS, and other comb(s) spread in or over other symbols. SSBs may convey or request NZP CSI-RS and may or may not distinguish between DFT-S-OFDM and CP-OFDM.

SSBs may have a resource muting pattern in certain embodiments, such resource muting pattern may convey certain information about the transmitting device. For example, patterns or comb patterns which have resources muted, may convey capabilities, frequencies, beams utilized or timing information (or any other information about the transmitter). Muted resources may be utilized for other transmitters to transmit other SSB information.

SSB content and/or beam switching, frequency or timing of transmissions may be used to request that a UE provide capability information as it relates to transmissions of the SSB. For example, the SSB may indicate a capability of the BS or other transmitting station and then the UE may transmit a capability identifier which identifies capabilities according to the set of capabilities identified by the transmitting station. For instance, if the transmitting station transmits on a certain frequency, the UE may respond with capabilities organized or limited to that frequency or frequency band. For example frequency band 2 (or frequency band 1, or 3) may have certain transmission capabilities are not associated with other frequency bands and so a limited capability report may be provided based on information discovered via SSB or other signaling transmitting by a transmitting station. The UE may report capabilities to another device via sidelink or V2V type communication based on the frequency band of another device. The SSB may supply a time/frequency/beam resource for transmission of the capability information to the device which transmits the SSB or another device. The network may provide certain services/features to the UE, as is disclosed herein, based on the capability report.

Instructions to the UE may occur in response to a sudden beam failure, a beam failure that occurs at a certain time of day repeatedly, a beam failure that results in no other suitable beams, or the like. A base station may provide a request for vision related information to a co-located or non-collocated base station which is involved in a joint transmission with the base station. In a cell free environment, it may be that each BS performs beamforming individually or it may be that each BS transmits a subset of beams in an overlapping time/frequency manner or sequentially with other BSs. Networks may be mixed mode networks, for example, in dense deployments the network may operate in a cell free mode, while in sparce deployments in rural areas may operate in a cell based mode. Base stations may cooperate and share information, for example, CSI information via a wireless relay.

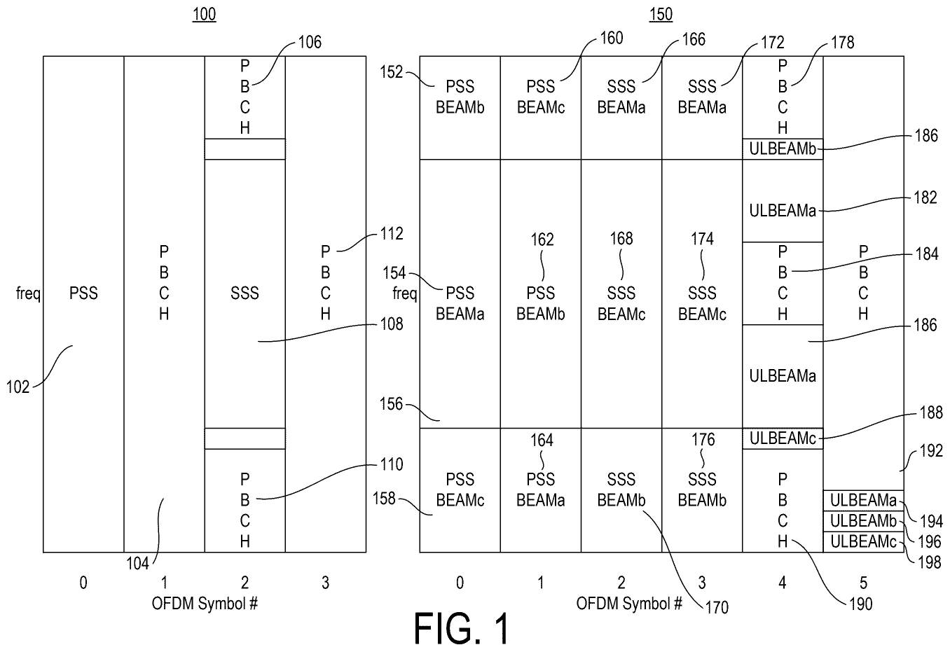

FIG. 1 is an illustration of SSB designs 100, 150, wherein the first design 100 comprises PSS 102 in a first OFDM symbol, PBCH 104 in a second OFDM symbol, PBCH 106/SSS 108 and PBCH 110 in a third OFDM symbol and PBCH 112 in a fourth OFDM symbol. SSB 150 includes PSS beam-b 152/PSS beam-a 154/PSS beam-c 158 in a first OFDM symbol, PSS beam-c 160/PSS beam-b 162/PSS beam-a 164 in a second OFDM symbol, SSS beam-a 166/SSS beam-c 168/SSS beam-b 170 in a third OFDM symbol and SSS beam-a 172/SSS beam-c 174/SSS beam-b 176 in a fourth OFDM symbol. In the fifth symbol, SSB 150 includes PBCH 178, UL beam b 180, UL beam a 182, PBCH 184, UL beam a 186, UL beam c 188 and PBCH 190. SSB 150 includes PBCH 192, UL beam a 194, UL beam b 196 and UL beam c 198 in a sixth OFDM symbol.

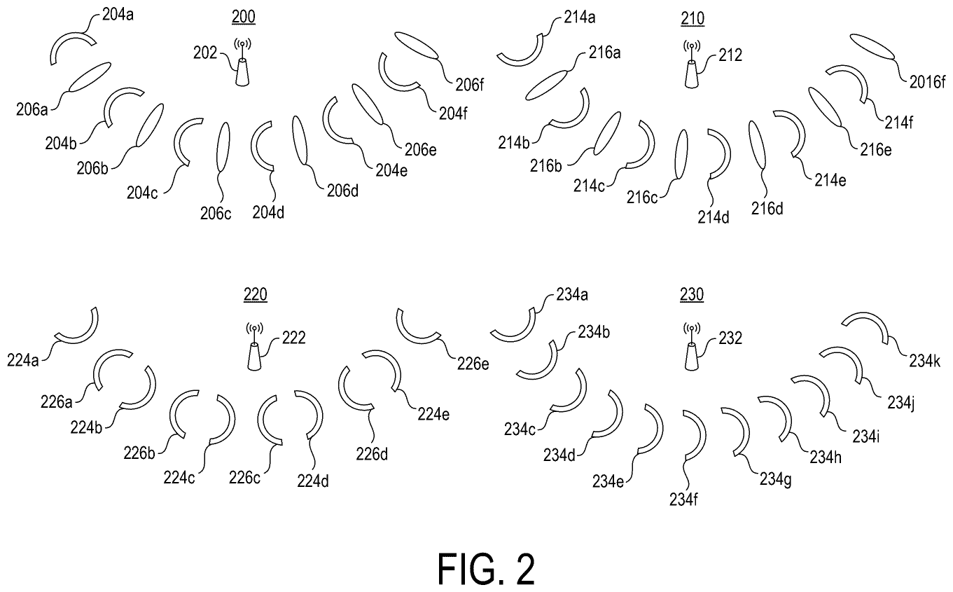

FIG. 2 illustrates a multi-TRP examples 200, 210, 220, 230, wherein TRPs 202, 212, 222, 232 transmit straight line beams and parabolic beams. Example 200 shows a TRP 202 transmits parabolic beams 204a-204f and straight line beams 206a-206f. A straight line beam may immediately follow a parabolic beam transmitted in one direction.

TRP 212 may transmit parabolic beams 214a-214f interspersed with straight line beams 216a-216f. In this way, TRP 212 may transmit a straight line beam following a parabolic beam transmitted in another parabolic direction from TRP 202. The parabolic beams may be of a same shape albeit transmitted at a different angle. TRP 222 shows a transmission scheme 220 wherein parabolic beams are transmitted back to back. A first parabolic beam 224a is transmitted and then another shape parabolic beam 226a is transmitted. In this way parabolic beams 224a-224g are transmitted interspersed with parabolic beams 226a-226g. TRP 236 may transmit all parabolic beams 234a-234k.

Parabolic beams may each be of different shapes, for example having narrower or wider endpoints. In embodiments, a first SSB may comprise all straight beams, while a second SSB performed after the first SSB may be comprised of all parabolic beams or may or may not include some straight beams. Parabolic beams (or other shaped beams) may be employed to promote physical layer security and each beam may be tested accordingly (e.g. based on SNR) and compared to a threshold used for determining whether a recipient may be a legitimate recipient vs an adversary.

SSB transmissions may alternate phase of the parabolic beam such that two immediately transmitted beams are of the same size and amplitude, however they have opposite phases. Phases may be slightly changed at each instance of a transmitted synchronization block. A UE may report a beam quality of a preferred straight line beam only based on capability. A UE may report a parabolic beam only based on capability. Alternatively, some UEs may report both straight beam quality and parabolic beam quality at a fixed or variable time interval after receiving SSB. By monitoring for parabolic beams, a UE may determine an operating frequency, for example, an operating frequence in the THz space and/or ˜7 GHz to ˜20 GHz range and sub-THz space. UEs may perform similar beamforming procedures and transmit beams to base stations. The BS may report beam quality similarly. The UE or BS may detect a timing based on reception of parabolic beams. Both mobile devices and base stations may detect multipaths created by the beams transmitted by the other side and determine delay and doppler parameters. The devices may then combine signals received by each of the multipaths before decoding a combined signal by separating received signals by their angles of departure/reception. By separating each received multipath signal into a channel, each channel may be processed separately (and receive information fed back, e.g. via CSI, to the transmitter) and then combined before decoding. Devices may have to compensate for movement or rotation of the wireless device and/or movement or signal blockage from other devices over time. UEs may, based on frequency parameters, for example, frequency above a threshold frequency, calculate and combine doppler and delay while, on other lower frequencies, not do so. Other loss type parameters may be determined and used in transmission scenarios, for example, geometric loss, atmospheric attenuation, beam scattering and scintillation loss may be estimated and used for conveying data. Loss information may be determined via echo detection.

SSB patterns may be transmitted according to subcarrier spacing, frequency range and/or based on any other parameter disclosed herein and these may convey doppler spread and delay information to a UE. Networks may only use parabolic or rainbow shaped beams in certain frequencies, for example, above THz range. The deflection of each parabola may be modified in time, for example, achieving 360 degree coverage of a UE or base station during synchronization or during data transmission. In embodiments, eNBs may support millimeter wave and higher frequencies using component carrier aggregation (for example, supporting a combination via aggregation of any of the technologies herein). Additionally, FR3 may be supported by certain devices, including frequency ranges of 7.125 ghz to 24.25 ghz.

SSBs may be transmitted in various symbol patterns and these patterns may alternate to convey certain information to a receiver. In embodiments, a first symbol may be a PSS symbol, second symbol may be an SSS symbol, third symbol may convey PBCH and fourth symbol may convey PBCH. Any symbol may occupy more or less space in the frequency domain. For example, a first PBCH symbol may occupy more space in the frequency domain than a second PBCH. Preferably, synchronization signals (which may be beamformed according to narrow beams, wide beams, parabolic beams, or other types of beams), may occupy less of the frequency domain than PBCH. One or more synchronization signals may be parabolic based, while one or more other synchronization signals may not be parabolic based.

SSB design: In embodiments, SSBs may have variable length in the time domain and may be transmitted on demand when UE enters cell. Information about the SSB (including an SSB length) transmitted by a base station may be signaled to another base station, a UE or a group of UEs via DCI or RRC signaling. The UE may assume that certain SSB signals are quasi collocated with another transmission that is made to the UE or to another UE of which the UE is able to detect. For example, a positioning reference signal or another reference signal which is transmitted at a higher frequency and/or more frequently than the SSB signal transmitted by the base station. The SSB may include group specific information, RRC information, DCI information, MAC information etc. The SSB may be group specific and may schedule another SSB transmission which is transmitted directly or on a UE specific basis which is beamformed to the UE.

In embodiments, a UE may receive a group SSB. The UE may decode the group SSB based on a group based RNTI or a RNTI dedicated for UEs which are not associated to the BS but are associated to another BS. The UE may perform positioning, ranging and may compute signal reception quality based on reference signals provided in the group SSB. The group SSB may comprise a data portion which indicates time, frequency and/or beam resources for a subsequent SSB which may be in a different frequency band or portion than the group based SSB. For example, the group based SSB may be on a band in the <1 GHz range, a band in the ˜3-6 GHZ range or a millimeter band and may also be transmitted in frequencies in the 7-15 GHz centimetric range and 90-300 GHz<THz range. Any one or more of the other bands may be used for receiving the UE specific SSB using a UE specific RNTI. There may be certain UEs which are capable of receiving only the group specific or only a UE specific SSB, however, for UEs which are capable of receiving the group specific SSB first, the high capability UEs may receive the UE specific SSB on resources indicated by the group SSB. The UE may transmit an indication that the group SSB was received, wherein the indication may be transmitted on dedicated group specific signaling resources for which other members of a reception group are allowed to use on a CDMA or other manner. Alternatively, or in combination, each UE may transmit on contention based resources an indication that the group based SSB is received. Similarly, when a UE receives the UE specific SSB, the UE may indicate successful reception by transmitting RACH on contention or contention free resources of a same or different frequency band than which the UE specific SSB is received on. UE specific may have a greater or smaller frequency utilization than the group based SSB. UE specific may have a greater or smaller time utilization than the group based SSB. UE specific may have a greater or smaller beam utilization than the group based SSB.

In embodiments, a base station or other transmitter transmits an SSB or group of SSBs in response to cell entry of a UE or based on a wake up signal from another neighboring bs. Some transmitters may begin transmitting SSBs (which may include wake up signal information) using small time/frequency segments at certain beam subsets and then expand into SSB transmissions with larger frequency or time occupations as needed, based on signaling received or not received from devices in range or devices which are anticipated to be in range. In some embodiments, transmitting in additional beams may be used to discover additional users only when those segments are detected as not having formed interference. SSBs and other signals may be transmitted in part or in whole in each one or more of the following frequency ranges: <1 GHz range, ˜3-6 GHZ range and millimeter band and including frequencies in the 7-15 GHz centimetric range and 90-300 GHz<THz range. Other ranges, outside of these ranges, may also be used for SSB and signal transmission.

SSBs and other control signaling, for example, DCI signaling may specify information regarding gaps and transmission/reception restrictions in the time, frequency or beam domain. For example, an SSB may configure or specify in combination with RRC or other signaling a DCI bit size for a DCI used to indicate information about transmission gaps associated with a particular spectrum, frequency space, channels number of subcarriers, etc. The DCI may be a fixed size or configurable via RRC or other signaling. Based on the SSB and DCI, a UE may decide to ignore a particular measurement gap that may have been configured via other methods. SSBs pay provide a bitmap indicating control information such as whether or not to skip reception of other SSBs transmitted by the same or different transmit unit in the same or different frequency spaces.

SSBs may be coded using any one of the techniques disclosed herein. They transmitted via a queue based approach depending on the resource combinations that they occupy, e.g. a first time second time third time fourth time and so forth. They may be transmitted in bursts. There may or may not be a reception response after knowing that a UE enters a cell via communication from another bs which wakes from the UE.

The following are example synchronization signal block (SSB) designs. Some designs may incorporate time/frequency elements that are conditionally utilized for uplink. Each signal, for example, PSS, SSS, PBCH, MIB, SIB, PUCCH, DCI etc, or any other signal transmitted herein, may be transmitted only on demand as necessary and if not necessary, each segment may be substituted with another one or more of PSS, SSS, PBCH, MIB, SIB, PUCCH, DCI. In some embodiments, a device may transmit SSB in multiple frequency bands, for example, at an overlapping time or non-overlapping time. In these embodiments, a device may determine to transmit information about a subsequent SSB from within a first SSB. For example, the PBCH or any one of the SIB portions may include a field which specifies a frequency or time offset, a beam, or other information which signals how and when to receive a following SSB on another band. In embodiments, a periodicity and a bitmap may be used for conveying information fields. Uplink fields may be used for SSB receiving devices to provide feedback, including CSI feedback, requests for on demand SSB portions, including control and data portions. Any other information disclosed herein may be provided on uplink to control the SSB or future SSBs. In embodiments, SSBs may be transmitted over slots which occupy both uplink and downlink symbols. In embodiments, uplink and downlink signaling may be sent on time/frequency overlapping symbols using directional beamforming. Uplink signaling may be used to activate downlink SSB indices that are not transmitted otherwise.

A device may transmit or receive separate SSBs according to traffic type, for example, one SSB may be associated with XR traffic and its frequency spread, timing and transmission offset may be associated with XR traffic parameters. Other SSBs may be transmitted by a same or different base station or other device and may convey parameters associated with different traffic types. Periodicity, frequency use and beam subset for use by a group of SSBs may be indicated via broadcast DCI type transmission or may be groupcast to a certain group of UEs which are within a beam subset and have certain matching capabilities which either the device transmitting the SSB is aware of, or another device which provides the DCI is aware of.

Beam quality reporting may be performed during SSB transmission, for example, via an index which is identifiable. This may be done based on DCI signal allocation from within the SSB or alternatively RRC signaling and reception of a certain beam or best beam pair or tuple may be employed. The beam pair or tuple may comprise beams of different types, different shapes, beams received on different frequencies, and/or may be based on beams received at the same or different times. Beam pair may be selected based on reporting potentials to network and receiving responses or determined based on receiving RRC configuration for automatic UE selection of aggregated UEs may do the measuring and reporting or BSs may do the measuring and reporting based on transmissions made by the UE. As bandwidth increases, more beams used by the UE or BS may be parabolic or other shaped beams. After determining a certain beam, for example, a parabolic beam, the BS and UE may negotiate (using a request/response) messaging scheme, a width of a beam pair. The request response procedure may negotiate a parabolic beam for uplink or downlink and another beam type for the opposite direction.

SSBs may be transmitted using orthogonal data streams. For example, if a system is configured to support two or more data streams at a given channel frequency (and/or above), the system may use two data streams independently polarized and may transmit SS blocks independent on each data stream. In other embodiments, SSBs may be alternated on each data stream and/or each SS block may be transmitted simultaneously on both data streams. In embodiments, SSB signals or individual blocks may be transmitted only on a certain data stream. For example, SSB symbol1 may be transmitted on data stream 1, SSB symbol2 may be transmitted on data stream 2, SSB symbol3 may be transmitted on data stream 1, SSB symbol4 may be transmitted on data stream 2 and so forth. Individual data streams may comprise certain control information only, while other data streams may be used for data elements. Certain information may be provided on a single data stream which indicates information, e.g. a size, position, timing, or the like of data or control information of a second data stream (which may or may not be polarized differently). Polarization may be performed according to Ultra-Wideband Terahertz Integrated Polarization Multiplexer by Gao et al. as disclosed herein by reference in its entirety.

Using polarization diversity, feedback may be provided on one or more data streams. For example, a receiver (e.g. a UE, base station, mobile station or the like), may provide RRC parameters which configured certain options, including feedback options to receive feedback as to a preferred operating frequency or band, a polarization extinction ratio, a recommended waveguide type, penetration depth, coupling gap, with of a selected bridging waveguide, a mode or phase selection quasi even and quasi odd (in phase and out of phase mode), level of mode interference, bandwidth, crosstalk measurement, crosstalk per frequency per stream, power, sample shift, rotation, transmission coefficients. Feedback and RRC parameter configuration may be interlaced or multiplexed with ODFM parameters. For example, a UE may provide feedback of an OFDM transmission multiplexed with feedback of a polarization diversity transmission (using one or more of an OFDM or polarization diversity transmit scheme). UEs and base stations may map certain QoS flows to certain transmission schemes, for example, high QoS flows may be mapped to a polarization diversity transmit scheme, while low QoS flows may be mapped to OFDM schemes. Certain DRX schemes may apply for some access schemes and not others, based on any parameter defined herein reaching a threshold value.

In examples, a UE or BS may predict a set of future beams, based on a set of beams utilized in the past at given times, locations, angles of operation, etc. beam prediction may be based on information received from other UEs, for example, via sidelink communication or via a base station. Prediction parameters for measurement and other prediction may be provided via RRC. The UE or BS may then monitor the quality of transmission or reception based on beam selection and feed back information for making future estimates and learning. N may be different depending on whether the beam prediction is made in spatial domain vs. time domain.

AI/ML techniques may be utilized to determine a number (N) of reports to make and/or a number of reporting instances for inclusion in a report. The number N may be based on higher layer signaling, for example, MAC/RRC layer signaling. In some cases, N may have a fixed maximum or may be based on conditions including: signaling quality, CSI/CQI, quantity of each report element, for example, if a reporting element is a certain bit length, the N may be larger if the bit length is lower than a threshold. In embodiments, if a UE is not expressly configured with N, the ue may report its selected N in advance by indicating a length field, number of bits, number of reported elements, etc. in a data structure for which the information is transmitted in.

Transmissions may be performed in a distributed fashion, for example, transmission may be made on subcarriers across one or more bandwidth allocations. In some embodiment, transmission resources may span multiple carriers with interspersed frequency portions not transmitted on due to detected busy or via sensing methods. This may apply to various transmission methodologies and/or topologies (e.g. point to point, mesh or broadcast).

Distributed methods may employ the concatenation of one or more apportioned transmissions, e.g. transmission portions which are of less than a standard unit, for example, less than 20 mhz, 40 mhz, etc. and a concatenation with transmissions made using full standard units, e.g. plurality of 20 mhz, 40 mhz, 80 plus resource sizes. Trigger frames and PHY layer signaling, e.g. DCI may be utilized to specify transmission concatenation types and/or combinations. Different preamble/header transmissions for distributed MIMO, wherein preamble or header portions may contain a subset of parameters disclosed herein and be transmitted separately such that each transmitter does not include entirely the same parameters. The transmitters may each separately transmit preambles, but jointly transmit data or vice versa. Certain transmissions may be made in part on shared subcarriers and in another part on individual subcarriers, wherein preamble portions indicate a subcarrier, timing allocation and beam (but may only indicate beam when sharing subcarriers is applied). Transmitters may use different beams for a subset of subcarriers of a channel, e.g. when an IRS is available, the IRS may be used for certain subcarriers but not others. The transmitter may apply different transmission characteristics to different subcarriers, for example, different MCS, different number of spatial streams, number of antennas, etc. When antennas of a plurality of APs form an antenna, the antenna may transmit on different directions for each of one or more subcarriers.

In some cases, when a transmitter is allocating time/frequency transmissions, a transmitter may allocate time resources separately, for example, by setting NAV settings for each portion of a frequency spectrum with different timing allocations. A binary value may specify whether one, two or more NAV settings are included in a packet. If more than one NAV setting is made, an order of the NAV settings may specify NAV settings for a particular order in frequency domain. For example, an order may be specified top down, i.e. from high frequency to low frequency to indicate NAV settings for two frequencies. More than two different frequency parameters may be indicated. Other indicators may be used to indicate frequency spectrum allocations. For example, any frame which includes a frequency indicator, the receiver may interpret the frequency indicator as an offset indicator, e.g. assuming a frequency parameter is provided, the receiver may interpret the frequency indicator as being a starting or ending location for the frequency in which is to be changed to, altered, etc.

A UE may report a capability identifier which indicates which subbands it may support for subband full duplex. Additionally, the same indicator or a different indicator may indicate which subbands and a number of subbands which the UE is capable of operating subband full duplex. An RRC configuration may be received, based on the capability indicator, which configures UEs for subband full duplex operation. Options to configure SBFD operation include DCI pattern based configuration which overrides another DCI based pattern which may or may not be an SBFD pattern. There may be cases where multiple when two patterns are configured, for example, one configured by SIB and one configured by other RRC parameters. In this case, the UE may need to make a judgement on which pattern set to operate under. For example, RRC configuration received subsequent to SIB may be relied upon. In some cases, RRC may specify a number of TDD-UL-DL patterns and their periodicities for use in multiple TRP scenarios. In some cases, a plurality of TDD-UL-DL patterns may be specified for each TRP and the UE, may via DCI or other signaling, determine which pattern to use for a given transmission.

Pathloss calculations may be based on a current pathloss plus an updated delta pathloss as calculated or provided by the network in RRC MAC or PHY layer signaling. For sTRP/UL mTRP scenarios where there are a different number of uplink TRPs vs downlink TRPs, for example, there may be more uplink TRPs than downlink TRPs or vice versa, a pathloss value may be calculated based on the number of TRPs in total, the number of TRPs, interference area coverage, modulation types, UE movement rate direction etc., pathloss may be calculated as a loss between two antennas or among elements in a single or multiple panel set of elements used to communicate with the TRPs, antenna height, reason(s) for accumulating TRPs, based on previously defined pathloss parameters, etc.

A variable length DCI format may provide an indication of a pathloss value along with other fixed or variable length values according to parameters disclosed herein. The DCI may have a RNTI value set according to its contents. For example, a number of pathloss values may be provided by way of DCI, each pathloss value indicative of a pathloss value for a corresponding transmission to a TRP which may or may not be collocated with another TRP. The DCI may specify a number of pathloss values included and may or may not be transmitted with a group based or single UE based RNTI. For example, if the DCI is group based, there may be pathloss values transmitted for other UEs for which the UE is to ignore. In this case, the DCI may either explicitly indicate an offset for the UE to use to decode its own pathloss value(s) or the UE may receive an offset indicator via RRC such that the UE can decode pathloss based on the offset provided. A pathloss offset provided via DCI may apply to more than one transmission (or to more than one TRP or cell of a TRP). Networks may also be cell free (or joint) in embodiments. Pathloss may be correlated or calculated based on a TCI state. Pathloss may be calculated using previously determined pathloss values (historic values). A network may configure the UE with historic data for which the UE may determine pathloss by estimating less frequently based on a comparison to historical data.

Exploiting Beam-Split in IRS-aided Systems via OFDMA, by P. Siddhartha, discusses aspects in using intelligent reflective surfaces (IRSs) to compensate for channel propagation losses. A wireless device may determine to exploit beam split depending on the frequency, depends on the bandwidth, and/or depending on number of subcarriers spread over the bandwidth. This information may be determined by the UE autonomously, based on information received from an IRS or via information provided by a base station. Devices may make a determination whether to measure and report CSI (estimate link path loss, estimate channel gain, estimate the finite delay spread, estimate the frequency representation of the channel estimate fading effects, etc.) based on information provided by a network node. Devices may determine number of IRS and number of IRS elements, number of UEs, number of base stations, and base station types (e.g. satellite, ground based IRS, mobile base station, etc.). Based on the above estimates, a UE or base station may determine to provide control information and transmit to one or more UEs on certain subcarriers according to the estimated conditions and taking into consideration beam split. System information may provide information to UEs indicating the time, resource and frequency parameters for making the channel estimates. Alternatively or in combination, this may be done via DCI, MAC or other RRC type signaling. A scheduler may be implemented such that the a scheduling grant (in the uplink, downlink or sidelink) is provided to a UE according to a best subcarrier. A UE or BS may provide feedback to the IRS indicating an IRS element pattern according to a time/frequency/beam estimate. Relays and other wireless devices may exploit beam split in transmissions and may employ a request/response scheme to learn a number of UEs in certain areas including whether or not UEs are in active/connected mode. For example, by transmitting a request to a server requesting same and receiving a response including information disclosed herein.

DCI and/or trigger frame indicates that individual symbol precoding applies for some period, but another precoding technique (e.g. block level) and not individual symbol precoding applies for some other portion of the transmission. The same DCI via the same format DCI or trigger frame may allocate resources for the UE to use to perform sensing, in a same or different frequency or channel, such that the UE can periodically perform sampling to determine precoding for the individual symbols or precoding for a slot or larger collection of symbols. A switch from individual symbol precoding to block level precoding may be applied or determined when a UE does not have channel feedback current to a threshold period (e.g. number of symbols, slots etc).

UEs may synchronize with multiple transmitted base stations within range depending on whether the network or base station is cell free or cell based. In embodiments, a cell based and cell free system may be employed service areas are and/or are not 1:1 correlated with a cell. For example, a service area may be configured on less than 1 cell and more than one cell.

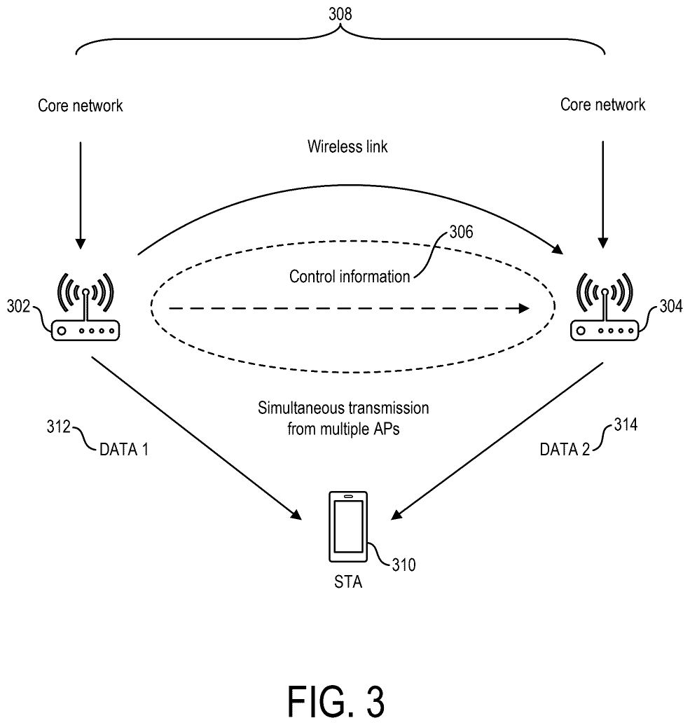

FIG. 3 is a network diagram 300 illustrating simultaneous transmission from multiple access points (APs). Wired, wireless devices or NTN devices may act as both repeater devices and secondary APs or secondary base stations which alternatively provide unique information to a mobile station. The network diagram of FIG. 3 is based on amendments to “Considerations on Joint Transmission” by Serizawa et al.

In an embodiment, control information 306 may be provided by a primary AP 302 which indicates wither the secondary AP 304 should repeat information transmitted over a wireless link between P-AP 302 and S-AP 304 and/or whether S-AP 304 should transmit unique information from the core network 308 (or another network) to the STA. The control information 306 may include: time information, beam information (which beams to use for S-AP 304 to reach the STA 310), switch information, for example information as to the radio conditions when to switch from a repeat mode to a unique data mode. One or both of the transmitters may be transmitting sensing and/or power based transmissions along with control and data transmissions. STA 310 may receive data 312 and/or data 314 from APs 302, 304. Time information may be used to specify an offset from a reference time or reference start time. In this way, S-AP 304 may act as both a repeater (which conditions are warranted) and as a unique data transmitter (again as conditions are warranted). The S-AP 304 may determine autonomously or via express signaling when to perform a repeat procedure vs when to transmit unique information. The STA 310 may indicate to either P-AP 302 or S-AP 304 a preference for repeat or unique. A STA may associate with one AP or another. There may be a channel load and/or number of STAs that exist within range of either AP that either AP uses to make a decision to act as a repeater or not. Either AP may report CQI information to the STA for forwarding to the other AP. APs may communicate such control information to one another over the wireless link, over a backhaul link, over a control link etc. it may be that aggregated links or asymmetric links are or are not employed.

Devices may receive unicast or groupcast DCI from network device(s) indicating transmission resources for an initial transmission, one or more relay transmissions, and an end transmission. The DCI may comprise a variable number of information elements specifying resources for the relay UEs, in this way, it may be a variable number of intermediary UEs which end up retransmitting data on behalf of a UE. Any of the DCI or SCI parameters disclosed in 3GPP 38.212 v18.3.0 uploaded on 2024 Jul. 3 may be included in DCI or SCI transmissions may be a base station or UE. For example, DCI formats may comprise variable or fixed length fields of: FDRA, TDRA (or any other channel, time or beam assignment based on a technique or technology disclosed herein), UE relay resource assignment (UE or UEs used for relaying), MCS, redundancy scheme (in terms of alternate relay devices). A UE may receive DCI specifying a variable number of SCI fields, for example, indicating 2 more SCI fields comprising: a frequency/time/beam allocation for more than one UE. The UE may provide the SCI fields to relay devices.

A header format may indicate whether a following segment is transmitted using unequal modulation. For example, the header format indicates a number of spatial streams implicitly by indicating a plurality of MCS indicators each representing the MCS of a separate stream. It may be that resource units are divided into a plurality of parts and separated in a time, frequency or beam manner, for example, in 3 or 4 parts. Certain formats may be specified for single user vs multi user formats or there may be a single transmission format employed.

A header may indicate a variable number of spatial streams used in an upcoming header segment based on a number of indicated MCS fields included in the first header portion. An ordering of the MCS fields may specify an ordering of spatial stream modulation segments, for example, a first in time field may be applicable to a first spatial stream, a second in time field may be applicable to a second in time spatial stream. It may also be that spatial streams are received by multiple stations, wherein only a portion of the total number of spatial streams are received by each of a plurality of STAs. It may be that one or more STAs does not need to decode all or some portion of the header format based on information received in the header format (or a preceding header portion).

Any of the techniques, frame formats and methods disclosed herein may be employed, for example, may be transmitted or received by devices as described in 6G Wireless Communications in 7-24 GHz Band: Opportunities, Techniques, and Challenges by Zhuang Cui et al. Devices may transmit SSBs, data frames, control information or any other data. Device may provide an SSB configuration to another device. Devices may also exchange control or data information. Devices may signal their own SSB periodicity wirelessly or via wired connection to another device and may indicate an SSB periodicity and offset for another device to utilize. A first SSB may specify: a subcarrier spacing of another SSB; a different cell id of a corresponding cell that transmits subsequent SSB; time, frequency and beam parameters of the following SSB, downlink transmit power of subsequent SSB, uplink transmit power for use in uplink portions of the SSB, code parameters for an uplink transmission during SSB, an uplink grant for a subsequent SSB. SSB may specify whether another SSB has been deactivated. These parameters may also be provided by DCI/MAC layer signaling, in some embodiments, within the SSB itself.

UEs may communicate with various devices, e.g. devices in a space network, air network ground network, with RISs, base stations, etc. UEs may employ full duplex methods in which the UEs may be in TX communication with a first device and RX communication with a second device or may be in full duplex (including sub band full duplex or other methods) with a single device (including both TX/RX) and/or multiple devices (some TX/RX, some RX and some TX). The resources may be fully overlapping in time/frequency or partially overlapping in time/frequency. At the UE side, the UE may use beam differences to determine a threshold for establishing full duplex, in combination with network signaling. For example, the network may configure, via RRC or other signaling, thresholds for establishing full duplex communication, e.g. the network may configure time and location based information for establishing the communication, a list of devices correlated with the time and location, an angle threshold for determining whether an additional TX or RX beam should be aggregated, based on a currently used beam or set of beams for one TRP compared to a potential beam for another TRP.

A network element may provide a UE with an RRC Reconfiguration message with a ToAddModList and/or a ToReleaseList that specifies, for each particular frequency portion, a list of TX and/or RX cells or links to add or release. The frequency portion may be a portion of frequency which the UE already has allocated or which is expected to tune to at a predetermined or to be determined time instant. Once the UE receives the ToAddModList and/or a ToReleaseList indicating a technology (space network, air network ground network, with RISs, base stations), frequency, beam angle or set of angles, location, time (time parameters associated with connection, for example, a satellite visibility time, an automobile travel time in range, a blimp or uav overhead time, etc.), line of sight visibility indicator, interference level the UE may make a decision as to when to add an additional link or release a link, for example, based on the parameters indicated. For example, based on a self interference level exceeding a threshold and a beam angle being less than or greater than a specified angle, it may mean that two spatially desperate beams are or are not compatible for full duplex communication. For example, the beam angle may be too low to mitigate the self interference. The UE may determine, based on network signaling and SIB broadcast signaling, that a new TRP is available to add for either TX or RX on overlapping time/frequency resources of another TX or RX of the UE, the UE may add such link until a failure threshold condition is met (again which may be specified by network signaling and/or determined by the UE autonomously). The ToAddModList and/or a ToReleaseList may be a tuple structure indicating a threshold for adding/modifying/releasing. The list may also include azimuth angles for which UE may be allowed to aggregate TRPs. Similarly, DCI may indicate an angle (e.g. in 3 dimensions, using degree may be a certain numeral in the X, Y, Z direction (and those can be different) which the UE is used to beam scan for a device, or used to communicate with a device or used to aggregate a communication on a time/frequency resource.

In embodiments, a UE may reports beams and beam angles to network elements. If the UE decides that self interference is small based on network feedback and self interference testing, communication is initiated/halted. If network and/or UE decides that self interference is small, communication is initiated/cancelled. Devices may or may not have separate antenna arrays. arrays may be sub partitioned based on signaling from network (e.g. sib or rrc).

Devices may select a precoding matrix based on a received precoding matrix indicator+some other combinations of information determined as described herein. A UE or TRP may become aware of a TRPs trajectory via sensing methods, via transmission information from the device, via signaling of another technology, e.g. wifi or Bluetooth reporting, or via another band or band combination.

A UE or BS may be using a beam in which two UEs find best. Both may use the same beams at the same time, or both may alternate using the best beam based on decisions made at the UEs or the BS. Another beam may be identified which is less than best, but the BS/TRP can transmit simultaneous transmissions at throughputs that beat the total throughput of UE1+UE2. This may be based on need or priority.

A UE or base station may detect a beam threshold event. For example, a UE may detect that a certain beam is better than a current beam based on a measurement threshold. The same may be true of a TRP or other device. In the case where a UE detects a downlink beam better than the current beam (e.g. by a threshold), the UE may indicate measurement information and an indication that the TWP should use such beam to reach the UE on downlink. In many cases, this may be advantageous from a throughput perspective, except for scenarios in which such a beam is currently occupied in the downlink by another UE. So, in this case, at least two (or more) UEs find a same beam as being a best beam. In this case, the best beam may be a large or small subset of all beams utilized. It may be that the beam serves all UEs in the cell or it may be that the beam serves only a small portion of the users in the cell. In the case where the beam is serving a large portion of the UEs in a cell (above a threshold), the TRP may determine which one of the two UEs should receive data using the best beam and which UE should receive data based on a second best (or other beam). The reason for this is that given a large transmission diversity, a TRP may be able to simultaneously transmit more data using more beams than an amount of data using only a subset of the beams. The TRP may make a priority analysis in determining which UE may receive data on the “best” beam and which UE may receive data on another beam. The decision may be based on a timer for using the best beam (which may expire) and on expiration another UE may use the beam, the decision may be based on a downlink or uplink priority of data, the decision may be based on a UE capability, the decision may be based on a quality of the beam, width of the beam, etc, the decision may be based on a location of the UE or distance of the UE or UEs from the TRP, the decision may be based on an amount of data that is expected to be served to the UE or group of UEs, the decision may be based on whether the downlink data is broadcast, groupcast or unicast data, etc.

A discovery procedure may be performed to discover elements in network and in a surrounding area. This discovery procedure may be based on wired, wireless communication and/or wireless sensing based methods. There may be relays that are used to determine a surrounding condition in terms of scope, distance, visibility etc. for sensing scenarios. The relays may employ their own sensing circuitry or may be coupled to other devices which employ sensing circuitry. A discovery procedure may be used where a requesting device provides a request having a counter which is decremented based on: a number of relays, a number of sensing devices, a number of communication devices. Once that number is reached, a response may be provided indicating a range of sensing. The sending device may send a new request with a higher number if necessary.

Any and all devices within a sensing and communication network may provide capability information (before or afterwards a request is sent), that may specify a minimum capability supported by the requestor and for only certain devices to respond/forward a request based on having those certain capabilities or above.

A reporting of joint networking/communication capabilities and sensing capabilities (e.g. sbfd, bands of sensing, beams, what devices can and cannot see, whether previous attempts to see an angle failed or succeeded, etc. may be provided based on a certain time or based on a timer that is applicable.

One or more UE may receive an allocation, via DCI, or other methods for transmitting sensing signals on the uplink. The DCI may specify resources used for transmitting certain data signals and other sensing signals. The DCI may specify frequency/time/beam resources and may specify that sensing/data signals are joint transmitted using the same time/frequency/beam resource or that sensing/data signals are joint transmitted using the partially overlapping time/frequency/beam resources and/or that sensing/data signals are joint transmitted using the entirely different time/frequency/beam resources.

Devices may have a certain clock synchronization and phase offset capability which may be reported in a cascading request/response. For instance, a request which is forwarded to multiple devices may be modified or the response may be modified with an indicator of each forwarding devices capabilities. The response may include only devices having a capability above a certain threshold or around that certain threshold. The response may be provided based on a growing array that includes information addressing devices (address, location, direction, capability) etc. only above and beyond those required, with some indicating minimum capabilities, etc.

Devices may be capable of capable of transmitting data and sending sensing signals simultaneously, receiving data and receiving sensing signals (e.g. signal responses or echos of other transmitting devices). In some embodiments, device may be sensing (transmitting or receiving sensing signals) in a different direction or frequency than the data is sent or received in.

The sensing signal may or may not be integrity protected from third parties deciphering patterns based on echos of the signals. For example, by transmitting a sensing signal, a third party receiver may infer that a transmitter is attempting to determine information about a particular target (alternatively or in combination, the target may be able to infer certain information about the transmitter). Thus, the transmitter may use certain techniques, including varying power, varying direction, varying modulation (or varying certain modulation parameters), that make a transmitted signal look like noise to the third party. The sensing signal may be encoded based on a key, or the transmitting parameters may be selected based on a random number or keyed selection, thus the receiver and third parties may see the signal as noise. Alternatively, the key may be passed to the receiver via a data only communication or a data/sensing based communication.

Existing DCI formats may be reused. For example, devices may transmit and receive existing DCI formats and DCI formats that have been modified according to a sensing approach. For instance:

DCI formats for the scheduling of PUSCH including format 0_0, 0_1, 0_2 and 0_3 may be supplemented by providing parameters disclosed herein in an uplink grant to a UE or other device such that the UE may transmit a sensing signal alone, with data or a data signal alone. These DCI formats may provide information to the UE for reception of a sensing response. The DCI may indicate target parameters for transmitting both the sensing signal, the data signal and parameters for reception of acknowledgements and sensing responses.

DCI formats for the scheduling of PUSCH including format 1_0, 1_1, 1_2 and 1_3 may be supplemented by providing parameters disclosed herein in a downlink grant to a UE. The UE may receive DCI indicating reception of a sensing signal alone, with data or a data signal alone. Parameters may indicate frequency/time/beam parameters individually or jointly for the transmissions. For instance, a DCI may provide an indication to use a matrix joint coded for sensing and data transmissions. DCIs may provide information indicating a periodicity of a sensing transmission and data transmission, e.g. a duty cycle of sensing vs. data.

Devices may use a full duplex transmit/receive in data and sensing signal simultaneously. For example, a device may split a transmission resource into different portions representative of sensing, data and power transmission. Alternatively or in combination, same resources may be used to provide sensing, data and power transmission by altering modulation transmission accordingly.

SSBlocks may have dedicated portions to sensing signal transmissions and portions which are transmitted and/or received on, wherein the transmitter also receives the signaling echo.

A UE may request that a base station or other device modify a directionality of an SSB, for example, by transmitting an SSB in an out of order direction, based on a request/response that may be part of the SSB itself. For example, in an uplink portion of the SSB, the base station or other device may receive an uplink request for sensing to be performed in a direction. Based on a priority included in the request, the base station may skip transmission of SSB in certain directions and may advance to an SSB transmission in the requested direction and then either backtrack and transmit the skipped directions or continue an SSB rotation beginning with the skipped direction. The base station may consider other parameters herein in a determination as to whether to process the request and/or where to continue the SSblock transmission from.

Beam and transmit parameters may be adapted based on requests for sensing. For example, if a device is requested to perform sensing, there may have already been a certain degree of information collected about a target, e.g. its size, shape, speed, trajectory, etc. These items may be used to increase, for example, a size of beam, a beam periodicity, one or more doppler compensation values to affect either the transmit signal or echo signal, and the like. In the case where SSB is used in part for data transmission and in part for sensing, the beam width and time spent transmitting using that beam may be modified based on a determined need for sensing transmission, for example, via request/response provided by a target device(s) or via a request/response provided by/from another device regarding the target(s). During beam sequencing operation, a sensing device adjust parameters (including a sweeping or scanning method) based on information received from other devices, e.g. vehicles, stationary devices, satellites and the like.

A periodicity of beam sweeping and scanning may be adjusted both in terms of the periodicity of a complete iteration and/or based on the duration of time in between each beam direction/estimation. A number of resources utilized and a number of resource locations may be configured based on higher layer signaling or autonomously determined based on certain application layer traffic types and/data priority. A combination of higher layer signaling and autonomously determining may be used when a UE is provided with a semi static allocation of resources to use for sweeping and the UE may select resources from the pool based on movement detection, traffic type or other elements. For instance, a UE may receive RRC configuration or reconfiguration, modifying beam sweeping periodicity, based on movement to a cell having a different beam pattern, having a smaller size, different operating frequency, etc. depending on whether an SCELL is configured, the RRC parameters may include sweeping parameters for both cells. A UE or BS may determine to drop or not use certain resources for beam sweeping based on transmission latency requirement(s) for some resources exceeds a threshold. The UE or TWP may use a counter or threshold comparator to determine when to override sweeping even in the event of high priority traffic. In embodiments where a UE moves from a stationary position to a movable position, the UE may be configured to energize movable antenna element(s) upon detection of an event, for example, a motion event, or traffic exceeding a threshold, etc. The device may overdrive the element(s) beyond a voltage require to move the element, in an effort to move the element faster, based on a RRC, MAC or DCI transmission indication (e.g. priority, latency, etc.).

There may be a need to speed up (e.g. shorten the time transmitting in a direction) or switching/alternating to a different beam in an SSB based on latency specified in the request/response. A response may include actual sensing data or just an acknowledgement.

Pilot overhead may be switched based on capabilities, so pilots previously used for other purposes may be exchanged for dedicated sensing resources, based on a request or number or capability of devices coming into range. There may be more or less need for pilot signals based on the number of users of a particular capability within a cell or nearby a cell transmitter. For example, if a number of release 15 users within a cell falls below a threshold, and a number of users of release 19 or 20 increases above a threshold, then the transmitting device may reduce the number of pilot signals transmitted and increase a percentage of transmission resources used for sensing purposes.

Synchronization signals may include power transmission signals at certain power level(s) based on responses receive during synchronization time periods. For example, the uplink portions of the SSBs may be utilized for both uplink data transmission and echo signal reception. This type of sensing may relate to a signature based detection procedure in terms of determining whether to apply power at a given resource per signature received in response. So, if a particular signature is receive in an echo response, then power may be increased to or above another threshold up until a maximum level is reached.

A signature may be determined based on certain events, for example, an unexpected disconnect, a device out of range event, a signal quality becoming below or above a threshold. Based on detection of the signature, a device may perform a connection, reconnection, handover or disconnection with another wireless device using an expedited connection request procedure as opposed to another procedure. Elements of the signature may be passed along in a connection request or any other message used for connection or reconnection.

Devices may make broadcast or groupcast requests for capability of non-3gpp sensor devices, Radar, lidar. sonar, wifi sensing, camera, etc, for example, using low level protocols like PHY MAC or or via higher level protocols, for example, using RRC or session initial protocol, for example.

When monostatic sensing is used to detect an object and an echo is not received, a device may repeat a monostatic sensing transmission using one or more of the same parameters as used earlier, for example, frequency or beam, but using some different parameters. When a threshold number of attempts is reached, the transmitter may change other parameters or switch to a monostatic approach in combination with a bistatic approach. Bistatic transmissions may consider noise due to a temperature measured at a transmitter, receiver or target device.

Communication devices may relay information herein using structured, semantic and linked data formats. Data formats may be markup based and may be machine and computer readable.

System information block (SIB) content may be needed for sensing parameters, including information on the sensing operation, time window(s) for sensing, operating period(s) for sensing, portion(s) of time/frequency/beam resources used for sensing, gap period(s), periodicity of other SIBs used for providing sensing information, whether sensing and power transmission can be used in the same device, same subframe, same slot, same symbol, etc. SIBs may indicate changing or different modulation parameters for subsequent SIBs, for which legacy receivers may not be able to decode. SIB content(s) may be modified, based on sensing transmissions that are performed during or subsequent to synchronization. In some embodiments, SIB content(s) may be based on information discovered via sensing signals provided by other transmitters (discovered via monostatic or bistatic sensing), SIBs may indicate a capability of participating in monostatic, bistatic or multi static transmissions and the associated time/frequency/beam availability for participating in such. SIBs and or RRC may configured different types of measurement/tracking parameters, e.g. 3d tracking, 2d tracking, may set a coordinate system for a particular area, device or time/frequency/beam, etc. 2D tracking may be used to initiate or convey a change to 3D tracking. SIBS may specify whether DFT-spreading is performed on top of OFDM or whether OTFS is to be used. SIBs may convey Radar Cross Section (RCS) information to be used by devices.

SIBs, RRC, MAC or DCI may be used for collision handling. For example, when scheduled for sensing, transmit or measurement, e.g. scheduled sensing may take priority over unscheduled transmission or reception, scheduled transmission may take priority over unscheduled sensing, scheduled reception may take priority over scheduled receive sensing. SIBs or transmission from other layers may indicate a transform, e.g. wavelet scattering or other transform used. A device may alternatively select a transform based on size, shape, speed, distance, material of the target. In some examples, a sensing transmission may be sent on one frequency and received by the same or another device at a different frequency. Transmissions may be sent accordingly and reception or echo resources are allocated on the another frequency.

In embodiments, base stations may ascertain a the time difference of arrival between other neighboring base stations via their transmissions and via reports made by intermediary UEs. For instance, if a UE is connected to two or more base stations, the UE can pass back TDOA signals to each base station for each base station to calculate timing difference between the station based on the feedback by an intermediary UE. This information may be used in determining a number of microbands to sample, a width of the microbands and/or whether to instantiate a microband SBFD sampling case.

In some embodiments, transmission reception points and/or UEs may be configured with movable antenna antennas and/or movable elements. Embodiments wherein elements may be fixed or movable on a panel are shown in FIG examples herein. Movable antenna elements may be configured to move in an effort to reshape wireless channels. Devices may report a number of antennas, an array size and an array configuration using a capability report. In embodiments, a configuration may be provided e.g. folding, dual scale, liquid fluidity, transformable structure, mechanically driven e.g. motor based, electronically driven, reconfigurable, etc. A time to change angle, direction, x,y,z parameter may be determined and used to determine whether a device may participate. For example, in a multi base station setup phase, a plurality of base stations may determine which base station is a primary bs and which base stations are secondary bs(s). It may be that a BS with greater reach (more power) acts as a primary bs or it may be that a BS with more or less configurable antenna capability acts as the primary bs. The determination of primary vs. secondary bs may be based on any device capability parameter disclosed herein. During coordination, devices may share more specifics about flexible antennas and antenna elements, for instance, devices may share the use characteristics, directionality, time to switch element direction(s), whether or not certain elements are scheduled at a time/frequency/beam, etc. It may be that certain base stations are selected and others are dropped (for a particular transmission or reception) based on antenna element activity. In some instances, depending on a channel quality, direction of UE/STA reception, two base stations may begin sharing data in advance of negotiated capabilities and transmission characteristics depending on whether those two BSs served a STA in a particular direction previously, or whether data indicates that a BS in a certain region can or cannot be reached at a particular channel quality level. Subsequently, after an allocation is sent by one or more BSs, to one or more mobile devices, flexible antenna elements may be varied based on the observed channel conditions as reported by BSs and/or mobile devices. BSs may make individual decisions to drop others based on flexible antenna elements performing below a threshold such that the complexity/power involved with a movable antenna transmission exceeds a threshold.

In embodiments, devices may have certain movable elements of an array with certain other elements being fixed in relation to those movable elements. These types of arrays may be useful for distributed multilink operation, wherein multiple disparate devices form a single transmitter, wherein each disparate device has one or more movable antennas and/or one or more fixed antennas. Some devices may receive a semi static configuration provided by another AP, BS or transmitter such that only certain elements are moving at a periodicity while others are not movable.

A same or different transmitter may employ a number of access points and/or a number of multiple link capable APs (that may or may not only operate on a plurality of frequency bands), wherein each device is separated in the spatial domain via movable antennas. In some embodiments a primary transmitter may send a multicast or broadcast transmission for a plurality of secondary devices to reconfigure antenna panels. For example, the primary device may provide an array comprising a field indicating an identifier of a receiving device, followed by a reconfiguration command, followed by a series of antenna movement indications. This may be done is sequence for each device being configured in the broadcast or multicast transmission. Alternatively, unicast methods may be used. Secondary devices may be configured to adjust movable antennas according to a movement trajectory of the device or antenna panel. There may be scenarios wherein the FCC allows transmission in certain frequency bands, for certain transmission priorities only. Additionally, there may be certain bands allowed at certain locations/times of data and not to exceed a power level. Before transmitting in a certain band, a device may ascertain a time of day, transmission direction, location etc. and may provide a request/receive a response indicating whether acceptable to transmit in a band. Alternatively, or in combination, for certain priority transmissions or short transmissions, a device may need not perform a request/response and may transmit immediately or after a delay.

In the cellular domain, DCI may specify information indicating an antenna movement characteristic directly or indirectly via RRC. In the direct case, the DCI may specify a time/frequency/beam resource based on the assumption that an antenna element or panel may change along the time/frequency/beam direction and the UE may apply that DCI. DCI may be individually addressed or group addressed and may convey information for aggregated links in a full duplex scenario, e.g. by specifying TPC commands for a plurality of links which are simultaneously active on different beams.

A transmitter may include, in a header portion of a frame, an indication of a beamforming change used to transmit a data portion which follows the header portion. For instance, a header portion may signal that the data portion (or chunks of discrete data portions) are being transmitted using a flexible beamforming technique using movable antennas. At each one of the data portions, a slightly different beam may be used based on the transmitter ability to switch beams in a given time period. There may be a need for gap portions between data portions when the transmitter is making a change or it may be that data is coded such that the receiver is unaware of the switch. For instance, assuming a data portion will have two different beams utilized by one or more transmitters alone or jointly, the header portion may signal a number of beams (or number of transitions), followed by a variable number of beam fields indicating a number of beams used according to the previous field. This way, a receiver can apply different receive beamforming throughout the reception of the data portion. The receiver may provide acknowledgements to different ones of the transmitter, assuming that different transmitters were involved in sending different portions of the data. Alternatively, the receiver may transmit a group based (or multiple receiver based) ACK frame and separately provide CQI to each physical transmitter based on, for example, the information in the header portion and/or other information. Header portions may indicate power values indicative of information provided to a receiver about a subsequent transmission or for used in power control in a directional manner to one or more physical transmitters. In embodiments, 2D beamforming may be performed in series or in parallel to establish 3D beamforming parameters. Frame formats may indicate whether they comprise channel quality information pertaining to 2D vs. 3D beamforming information. Based on a CQI threshold, a priority level, number of spatially disperse transmitters/receivers and/or another event or timer expiration, a device may trigger 3d beamforming and/or may revert to 2d beamforming.

Each physical transmitter may be tailored according to an individual SNR determined at a receiver and then, once each transmitter determines a best beam for the individual SNR, a joint transmission may be made in which a receiver provides SNR feedback (or other feedback) to the joint transmitter for tailoring individual antenna elements. It may be that antenna elements of a particular panel are moved sequentially before another transmitter moves its elements and/or it may be that antenna elements are adjusted in parallel before a subsequent transmission where SNR is taken. A combination of both approaches may be used. A signal to noise ratio which is currently estimated may be compared to an estimated SNR assuming a newly gained antenna (movable or not) is added to a single device or multiple device (joint transmission.) This may be done based on parameters received from another device or a network.

In some instances, the act of moving an antenna panel or element may be productive in modulating a signal. For instance, on a panel with multiple elements on which all or some are movable elements, by moving elements, e.g. during movement, they may each transmit on same time/frequency/beam elements, e.g. using a same tuner, but given the movement of the antenna, it may be that orthogonality is seen at the receiver assuming the receiver is pre-aware of the movement patterns (which may be configured or reported by the receiver). In this embodiment or others, UEs and TRPs may aggregate groups of different movable antennas per a given frequency/time/beam.

Transmitters of a group of transmitters making a joint transmission may individually or groupwise make a determination to pre-empt transmitting at certain time/frequency/beam resources and/or preempt transmission on certain movable antenna elements based on channel information, power, movement, receiver location, etc. Pre-emption may be performed, for instance, by a Wi-Fi transmitter (of a group of transmitters) in the event that information regarding certain SBFD symbols are being transmitted/received at similar time/beam/frequency resources. Similarly, cellular transmitters may preempt transmission assuming that Wi-Fi transmitters are operating on similar time/frequency/beams. When transmissions are made, the transmissions may only occupy secondary channel or other channel portions and may be made jointly by only certain transmitters of a group of transmitters, wherein those transmitting transmitters are not going to affect IDC above a threshold (or those certain transmitters are not expected to experience IDC on other links). Transmitters may negotiate an unavailability period based on time (duration), frequency and/or beam. Transmitters may jointly or individually specify a trigger frame that indicates which transmitters are being utilized for what time intervals. Each one of the joint transmitters may negotiate and coordinate a group transmission power based on neighboring UE/STAs or other devices within a cell or nearby in a cell free environment.

Our proposal introduces two new network entities: the Inter-network Resource Sharing (IRS) Gateway and the SIM Interaction Mapping Server (SIMSer). The IRS Gateway will facilitate seamless communication between networks of pertinent SIMs, while the SIMSer will manage and maintain a comprehensive database of SIM mappings. This architecture is complemented by the development of several new types of RAN (Radio Access Network) and Core Network messages, enabling efficient interaction between SIMs and optimized use of radio resources.

The implementation of these new network entities conserves radio resources by minimizing duplicate signaling and optimizing resource allocation. Despite the challenges associated with complexity, initial costs, and standardization, the potential benefits in terms of resource conservation and enhanced efficiency make this approach a compelling avenue for future advancements in mobile communication systems.

The mobile communication industry has experienced a significant shift with the increasing adoption of multi-SIM phones. Multi-SIM functionality allows users to leverage different network operators and plans within a single device, thereby enhancing flexibility and connectivity. Users can maintain separate SIM cards for work and personal use, benefit from better coverage, and take advantage of different pricing plans to optimize costs. However, the current architecture, where SIM cards operate independently, leads to inefficiencies such as duplicate signaling and underutilization of radio resources. Each SIM card independently manages registration, authentication, and other signaling procedures, often leading to redundant processes that consume valuable network and device resources. This redundancy not only affects the battery life of the device but also contributes to unnecessary network congestion.

To address these inefficiencies, this proposal introduces a novel approach involving the introduction of two new network entities: the Inter-network Resource Sharing (IRS) Gateway and the SIM Interaction Mapping Server (SIMSer). The IRS Gateway aims to optimize resource allocation by enabling resource sharing between different network operators, thereby reducing duplicate signaling and improving overall network efficiency. Meanwhile, the SIMSer is designed to manage interactions between multiple SIM cards within a device, coordinating their activities to minimize redundant processes and enhance battery life. By mapping and optimizing the interactions of SIM cards, the SIMSer ensures that only necessary signaling is performed, thereby reducing the overall signaling load on the network. This innovative approach promises to significantly enhance the performance and efficiency of multi-SIM phones, providing a superior user experience while optimizing network resources.

Below, we delve into the specifics of the Inter-network Resource Sharing (IRS) Gateway and the SIM Interaction Mapping Server (SIMSer), detailing their roles and the transformative impact they will have on the mobile communication landscape.

### Functionalities of the Inter-network Resource Sharing (IRS) Gateway

The IRS Gateway plays a pivotal role in the proposed architecture by facilitating seamless communication and resource optimization between networks associated with multi-SIMs in a single UE (User Equipment). The primary functionality of the IRS Gateway is to mediate interactions between different mobile networks pertinent to the involved SIMs, ensuring efficient utilization of radio resources by the multi-SIM carrying UE and minimizing redundant signaling. By establishing a centralized point for managing inter-network communications, the IRS Gateway enables real-time coordination between operators, leading to improved network performance and resource conservation.

One of the key functions of the IRS Gateway is to handle the SIM Interaction Setup process. When a UE with multi-SIMs initiates a request for inter-network cooperation, the IRS Gateway receives the interaction request and validates the credentials and parameters of the involved SIMs through communication with the SIMSer, as explained in the next section. This validation process involves checking the authentication details, subscription profiles, and network policies to ensure compliance and security.

Upon successful validation, the IRS Gateway coordinates with the core networks of both SIMs to establish a synchronized communication session. This process involves exchanging essential parameters such as encryption keys, QoS (Quality of Service) requirements, and priority settings. The IRS Gateway sets up a secure interaction session ID, ensuring that both networks are aware of the ongoing cooperation and can manage resources accordingly. Additionally, the IRS Gateway facilitates the negotiation of bandwidth allocation, latency requirements, and handover parameters to optimize the session's performance.

Moreover, the IRS Gateway plays a vital role in maintaining the session by continuously monitoring the interaction and facilitating the transfer of data. It dynamically adjusts resource allocation based on real-time network conditions, ensuring that the UE receives the best possible service without overloading any single network. This involves sophisticated algorithms for load balancing and interference management, which enhance overall network efficiency.

The IRS Gateway also supports advanced features such as adaptive scheduling and predictive resource management. By analyzing historical data and usage patterns, it can anticipate network demands and pre-emptively allocate resources, further reducing latency and improving user experience. In case of any disruptions or changes in network conditions, the IRS Gateway can seamlessly switch between networks, maintaining uninterrupted service.

### Functionalities of the SIM Interaction Mapping Server (SIMSer)

The SIMSer is a critical component in the proposed architecture, responsible for maintaining and managing the database of SIM mappings. Its primary functionality is to store, update, and retrieve mapping information for SIMs across different networks, ensuring that each SIM interaction request is accurately mapped, processed, and validated. SIMSer acts as a central repository that holds detailed records of SIM identifiers, network affiliations, and interaction permissions, providing a robust framework for managing inter-network communications.

When a UE with multi-SIMs initiates a SIM Interaction Request, the SIMSer receives a mapping request from the IRS Gateway. This request includes essential information such as the source IMSI/IMEI, target alias/phone number, and the type of interaction required. The SIMSer performs a detailed look up in its database to validate the interaction and retrieve the corresponding mapping information. This validation process ensures that the interaction is authorized and complies with predefined network policies, including security protocols and access controls. The SIMSer uses advanced algorithms to match the SIM details with the correct network configurations and permissions, ensuring seamless inter-network communication.

Once the validation process is complete, the SIMSer communicates the relevant mapping details back to the IRS Gateway. This communication includes encrypted interaction parameters and session initiation protocols that facilitate the setup of a secure and efficient communication session between the networks of the involved SIMs. The SIMSer along with PCF (Policy and Charging Function) plays a vital role in ensuring that both networks involved adhere to the agreed terms of interaction. This involves negotiating terms such as bandwidth allocation, priority levels, and service quality, ensuring that the interaction is optimized for both performance and security.

Additionally, the SIMSer continuously updates its database to reflect changes in SIM configurations, network affiliations, and interaction policies. This dynamic updating process is crucial for maintaining the accuracy and reliability of the SIM mappings, allowing the system to adapt to changes in real-time. The SIMSer employs machine learning techniques to predict and preemptively resolve potential conflicts or inefficiencies in SIM interactions, further enhancing the system's robustness and performance.

By centralizing the management of SIM mappings, the SIMSer significantly enhances the accuracy and reliability of inter-network interactions. This centralization not only streamlines the validation and setup process but also facilitates more effective resource allocation by providing real-time insights into network usage patterns and demands. The SIMSer's ability to manage and optimize these interactions contributes to improved overall network performance, reduced latency, and enhanced user experience, making it an indispensable component in the proposed multi-SIM architecture.

### Messaging Protocols for Initial Registration and Authentication Procedure

In order to facilitate seamless interaction and cooperation between multi-SIMs across different networks, the introduction of new types of RAN (Radio Access Network) and Core Network messages is essential. These messages are specifically designed to support the proposed functionalities of the IRS Gateway and SIMSer, enabling efficient communication, resource sharing, and coordination between disparate network entities. The new messaging protocols aim to optimize overall network performance by reducing redundant signaling and enhancing the management of radio resources.

The new types of RAN and Core Network messages will include, but are not limited to, SIM Interaction Request (SIR), SIM Interaction Acknowledgement, SIM Interaction Mapping Request (SIMR), SIM Interaction Mapping Response, SIM Interaction Setup (SIS), SIM Interaction Confirmation (SIC), SIM Interaction Data Transfer, SIM Interaction Termination Request, and SIM Interaction Termination Confirmation. These messages will ensure that each stage of the SIM interaction process, from initial request to final confirmation, is meticulously handled, providing a structured and efficient framework for inter-network cooperation. These new message types are explained below:

### Registration and Authentication:

Both SIMs (SIM-1 and SIM-2) register with their respective networks using standard procedures. During this phase, each SIM undergoes the typical authentication process, where the mobile network verifies the subscriber's credentials. This step ensures that both SIMs are authenticated and authorized to access the network services. The registration process involves exchanging signaling messages such as Attach Request and Attach Accept, which confirm the successful attachment of the SIMS to their respective networks.

### Automatic Detection and Initialization:

When the User Equipment (UE) detects the presence of two SIMs, it automatically initiates a SIM Interaction Request (SIR) to the base station of SIM-1's network. This detection is facilitated by the UE's internal software, which identifies multiple active SIMs and triggers the interaction setup process. The automatic initialization ensures that the UE can manage multi-SIM interactions without user intervention, streamlining the process for seamless communication.

### SIM Interaction Request (SIR):

The SIR is sent from the UE to the base station of SIM-1's network, which forwards it to SIM-1's home network core. This message contains information about the presence of SIM-2 and requests the initiation of inter-network cooperation. The SIR includes the IMSI of SIM-1, the identifier of SIM-2, and the type of interaction required. This request is crucial for setting the groundwork for resource sharing and efficient communication between the two networks.

### SIM Interaction Acknowledgement (SIA):

The SIM-1's core network sends an acknowledgement back to the UE, confirming the receipt of the interaction request. The SIA message assures the UE that the request has been received and is being processed. This acknowledgement is essential for maintaining synchronization between the UE and the network during the interaction setup phase.

### SIM Interaction Mapping Request (SIMR):

SIM-1's core network sends a mapping request to the IRS Gateway. The SIMR message includes details such as the IMSI of SIM-1, the target network identifier, and the specific interaction requirements. This request is forwarded to the IRS Gateway, which acts as the intermediary for coordinating the interaction between the two networks.

### SIM Interaction Mapping Response (SIMR):

The Interaction Mapping Server (IMSer) provides the necessary details and validation for SIM-2. The SIMR response includes mapping information such as the validated credentials of SIM-2, interaction permissions, and any other relevant parameters required for establishing the inter-network communication. This response ensures that both SIMs are authorized and the interaction complies with network policies.

Coordination with SIM-2's Network:

The IRS Gateway communicates with SIM-2's core network to facilitate the interaction setup. This coordination involves exchanging information about the interaction requirements and ensuring that both networks are prepared for the upcoming communication session. The IRS Gateway ensures that the resource allocation and network parameters are synchronized between the two networks.

### SIM Interaction Setup (SIS):

The IRS Gateway coordinates the setup by sending connection parameters to both core networks. The SIS message includes details such as encryption keys, session IDs, and other necessary parameters for establishing a secure and efficient communication session. This setup phase ensures that both networks are aware of the interaction and can manage their resources accordingly.

### SIM Interaction Confirmation (SIC):

Both core networks confirm the interaction setup to SIM-1 and SIM-2. The SIC message provides confirmation that the interaction setup is complete, and the communication session can proceed. This confirmation is crucial for synchronizing the networks and ensuring that both SIMs can start the data transfer phase.

### SIM Interaction Data Transfer (SIDT):

Data transfer occurs between SIM-1 and SIM-2 through their respective core networks. The SIDT messages facilitate the exchange of data, ensuring that the communication is efficient and optimized for resource utilization. This phase involves transferring user data, signaling information, and any other necessary communication between the two networks.

### SIM Interaction Termination Request (SITR):

If either SIM needs to terminate the interaction, a termination request is sent to the core network. The SITR message initiates the termination process, signaling that the communication session should be closed. This request includes details such as the session ID and the reason for termination.

### SIM Interaction Termination Confirmation (SITC):

Both core networks confirm the termination of the interaction to SIM-1 and SIM-2. The SITC message ensures that the termination process is complete and both networks have released the resources allocated for the interaction. This confirmation is crucial for maintaining network efficiency and ensuring that resources are available for other communication sessions.

### Messaging Protocols for Call Setup Procedure

Below, we outline the messaging protocols for a call setup procedure that enable the advanced level of resource optimization.

### Call/Session Request Initiation:

When a User Equipment (UE) initiates a call or data session, it sends a Call/Session Request over the air interface to the primary network associated with one of its SIMs. This request contains information about the type of session (voice, video, data), the requested Quality of Service (QoS), and other relevant parameters. The primary network's base station receives this request and forwards it to the IRS Gateway.

The IRS Gateway, upon intercepting the Call/Session Request, checks if the requested resources can be optimized by leveraging the secondary network associated with the other SIM. This step involves analyzing the current network load, resource availability, and potential benefits of offloading some traffic to the secondary network.

### Resource Coordination Message (RCM):

The IRS Gateway sends a Resource Coordination Message (RCM) to the SIMSer to retrieve the mapping and resource status of both SIMs. The RCM includes details such as the requested QoS, available bandwidth, and the current load on each network. This message is crucial for assessing the feasibility of resource optimization.

The RCM also contains identifiers for both SIMs, ensuring that the SIMSer can accurately match the request with the corresponding SIM profiles and network conditions. This coordination ensures that the resource allocation plan is based on real-time data and network status.

### Resource Availability Check:

The SIMSer processes the RCM and performs a lookup in its database to check the resource availability and current network conditions for both SIMs. The database contains detailed records of network resources, load metrics, and historical usage patterns.

The SIMSer responds with a Resource Availability Report (RAR), which includes detailed information about available radio resources and optimal allocation strategies for the requested session. The RAR provides a comprehensive overview of network conditions, enabling informed decision-making.

### Resource Allocation Decision:

Based on the RAR, the IRS Gateway decides the best resource allocation strategy to minimize duplicate signaling and conserve radio resources. This decision involves analyzing various factors such as network load, resource utilization efficiency, and the potential impact on QoS.

The IRS Gateway may choose to use the primary network for voice/data traffic while offloading background or less critical data to the secondary network, or vice versa. This strategy ensures that critical traffic receives the highest priority and optimal resources.

### Resource Assignment Message (RAM):

The IRS Gateway sends a Resource Assignment Message (RAM) to both the primary and secondary networks. The RAM specifies the resource allocation plan, detailing which portions of the traffic each network will handle.

The networks adjust their resource allocation accordingly and prepare to handle the incoming traffic based on the optimized plan. This preparation involves setting up necessary channels, adjusting bandwidth allocation, and configuring network elements to support the resource distribution.

### Session Establishment:

The primary network establishes the call/session based on the RAM instructions. This involves completing the call setup process, allocating resources, and establishing communication channels.

The secondary network, if involved, sets up the necessary channels to handle its designated portion of the traffic. The IRS Gateway monitors the setup process to ensure seamless coordination and efficient resource use. This monitoring includes verifying that the allocated resources are utilized as planned and that there are no conflicts or bottlenecks.

### Dynamic Resource Adjustment:

During the session, the IRS Gateway continuously monitors network conditions and resource utilization. This monitoring involves real-time analysis of traffic patterns, network load, and QoS metrics.

If necessary, the IRS Gateway dynamically adjusts resource allocation between the networks to respond to changes in traffic load, QoS requirements, or network performance. This adjustment ensures ongoing optimization and conservation of radio resources throughout the session, maintaining high service quality and efficient network operation. This dynamic adjustment can include reallocating bandwidth, rerouting traffic, and modifying resource assignments based on real-time conditions.

### Dynamic Role Assignment and Resource Optimization for Dual SIM Integration

To further enhance the efficiency and user experience of multi-SIM integrated mobile phones, the assignment of primary and secondary roles can be implemented through both user discretion and network control mechanisms. Users may designate one SIM as the primary for network-intensive activities such as calls, data usage, work mode, and travel mode, while assigning the secondary SIM for less frequent activities like SMS and low-priority notifications. This role assignment can be dynamically switched based on usage patterns and battery levels, providing flexibility and control to the user. For instance, a user might set the work SIM as primary during office hours and the personal SIM as primary during evenings and weekends. This level of control allows users to optimize their mobile experience based on their specific needs and preferences.

Network-controlled role assignment offers an additional layer of optimization by monitoring network conditions such as signal strength and congestion. The network can automatically assign the SIM with better conditions as the primary, thus reducing roaming charges, failed attempts, and re-transmissions. For example, if the primary SIM's network is experiencing high congestion or poor signal quality, the network can seamlessly switch the primary role to the secondary SIM that has better connectivity. This not only lowers costs but also conserves power, ensuring a more efficient use of network resources. Additionally, this mechanism can help mitigate issues like network outages by dynamically adjusting SIM roles based on real-time conditions, thereby maintaining continuous service.

Implementing a unified registration process for both SIMs through the primary SIM can significantly reduce signaling overhead. By avoiding separate registration processes for each SIM, the system can streamline network interactions and enhance performance. This unified registration approach means that both SIMs share the same initial network handshake, reducing the number of signaling messages exchanged with the network. This efficiency not only improves network performance but also decreases the likelihood of network congestion and related issues.

Additionally, the primary SIM can stay in active or idle mode, while the secondary SIM remains in a low-power state, waking up only when necessary (e.g., for incoming calls or messages). This approach minimizes power consumption and extends battery life. For example, the secondary SIM can be configured to periodically check for notifications or messages and then return to a low-power state, thereby conserving battery. This intelligent power management ensures that the device remains operational for longer periods, which is especially beneficial for users who rely heavily on their mobile devices throughout the day.

To further optimize resource usage, advanced algorithms can be developed to dynamically adjust the activity levels of each SIM based on factors such as battery levels, usage patterns, and network conditions. These algorithms will ensure that the most efficient use of resources is maintained, providing a seamless and cost-effective user experience. For instance, if the battery level drops below a certain threshold, the algorithm might shift more activities to the secondary SIM to balance power consumption. Additionally, the algorithms can learn from user behavior over time, predicting which SIM will be needed and adjusting roles proactively. This adaptive approach ensures that users enjoy uninterrupted service and optimal performance, regardless of their usage patterns or external conditions.

The proposed solution offers significant benefits in terms of resource optimization and enhanced efficiency. By minimizing duplicate signaling, the solution ensures that radio resources are used more efficiently, which leads to effective resource allocation and conservation of valuable radio spectrum. This optimization is crucial in reducing the overall load on the network and improving the performance of mobile devices. For example, by eliminating the need for each SIM to independently negotiate with the network, the system can significantly reduce the number of signaling messages, which in turn conserves bandwidth and reduces the potential for network congestion.

Additionally, the solution enhances efficiency by enabling seamless inter-network cooperation. This means that SIM cards from different operators can interact seamlessly without unnecessary user intervention, improving the user experience and overall network performance. For instance, when a user with multi-SIMs moves from one coverage area to another, the system can automatically coordinate between networks to ensure continuous connectivity. This seamless transition is achieved without the user needing to manually switch SIMs or adjust settings, providing a more intuitive and hassle-free experience.

Moreover, the ability to dynamically manage and optimize resources between different networks allows for more robust handling of network traffic. In high-demand scenarios, such as during peak hours or in densely populated areas, the system can intelligently allocate resources to maintain service quality. This adaptive resource management not only enhances user satisfaction but also helps operators manage their network resources more effectively, leading to improved overall network stability and performance.

The proposed concept of Inter-network Cooperation and Resource Optimization for smart multi-SIM phones addresses significant inefficiencies in current mobile communication systems. By introducing the IRS Gateway and SIMSer, and developing new RAN and Core Network messages, we aim to revolutionize the way multi-SIM cards operate within a single UE. This approach promises enhanced efficiency, resource conservation, and centralized management, making it a compelling avenue for future advancements in mobile communication systems.

The IRS Gateway facilitates seamless communication and resource optimization between networks, ensuring that radio resources are utilized efficiently and reducing redundant signaling. This centralized management approach allows for real-time coordination between operators, leading to improved network performance and resource conservation. The SIMSer, on the other hand, acts as a critical component for maintaining and managing the database of SIM mappings, ensuring accurate and validated interactions between networks.

Together, these components create a robust framework for inter-network cooperation, enhancing the user experience by providing seamless connectivity and optimized resource usage. The introduction of new messaging protocols further supports this framework, ensuring that every stage of the SIM interaction process is handled efficiently.

Overall, the proposed solution offers a transformative impact on the mobile communication landscape, paving the way for more efficient, reliable, and user-friendly multi-SIM operations. As the mobile industry continues to evolve, innovations such as these will be essential in addressing the growing demands for connectivity and resource management, ultimately leading to a more sustainable and efficient mobile ecosystem.

What is claimed is:

1. A method performed by a user equipment (UE) configured to operate in a multi-transmission reception point (TRP) network and/or a cell free network, the method comprising:
receiving a first beam of a first set of wide synchronization signal block (SSB) beams transmitted by a first TRP;
receiving a second beam of a second set of narrow SSB beams transmitted by a second TRP, wherein the second TRP is different from the first TRP;
predicting, from the first beam and/or the second beam, a beam which is not transmitted by either one of the first TRP or the second TRP;
transmitting a random access preamble based on the predicted beam;
receiving, post synchronization, information indicating that Discrete Fourier Transform (DFT) spreading Orthogonal Frequency-Division Multiplexing (DFT-s-OFDM) is to be used for uplink communication with one of the first TRP or the second TRP;
receiving control information that triggers an uplink transmission;
determining a rank for the uplink transmission, wherein the rank corresponds to a plurality of spatial streams; and
transmitting data, to the one of the first TRP or the second TRP, using DFT-s-ODFM in accordance with the determined rank.

2. The method of claim 1, one of the first beam or the second beam is a beam of a four symbol SSB and another of the first beam or the second beam is a beam of a six symbol SSB;
wherein the six symbol SSB includes PSS in a first symbol, SSS in a third symbol, PBCH in a fifth symbol and additional PBCH in a sixth symbol.

3. The method of claim 2, wherein the UE is multiple subscriber identity module (multi-SIM) compliant;
wherein the four symbol SSB is received in a 5 mhz frequency allocation, 10 mhz frequency allocation or 20 mhz frequency allocation;
wherein the six symbol SSB is received in a 3 mhz frequency allocation.

4. A method performed by a user equipment (UE) configured to operate in a multi-transmission reception point (TRP) network or cell free network, the method comprising:
receiving a first beam of a first set of wide synchronization signal block (SSB) beams transmitted by a first TRP;
receiving a second beam of a second set of narrow SSB beams transmitted by a second TRP, wherein the second TRP is different from the first TRP;
predicting, from the first beam and/or the second beam, a beam which is not transmitted by either one of the first TRP or the second TRP;
transmitting a random access preamble based on the predicted beam.

5. A UE configured to operate in a multi-transmission reception point (TRP) network and/or a cell free network, the UE comprising:
a receiver configured to receive information indicating that Discrete Fourier Transform (DFT) spreading Orthogonal Frequency-Division Multiplexing (DFT-s-OFDM) is to be used for uplink communication with one of a first TRP or a second TRP;
the receiver further configured to receive control information that triggers an uplink transmission;
circuitry configured to determine a rank for the uplink transmission, wherein the rank corresponds to a plurality of spatial streams; and
a transmitter configured to transmit data, to the one of the first TRP or the second TRP, using DFT-s-ODFM in accordance with the determined rank.

6. The method of claim 4, wherein the first set and the second set are time interleaved.

7. The method of claim 4, wherein at least one of the beams is transmitted at a different power than another one of the beams.

8. The UE of claim 5, wherein the UE is configured to store configuration information for network access to two separate radio access networks (RANs), wherein one RAN is a terrestrial RAN and another RAN is a non-terrestrial RAN.

9. The method of claim 4, further comprising:
receiving another SSB transmitted by a second network operator which is different from a first network operator which transmits the first SSB and the second SSB, wherein the another SSB is transmitted via satellite;
switching to a network of the second network operator to maintain uninterrupted service, wherein the second network operator is in communication with a core network of the first network operator via an intermediary for coordination interaction among the first network operator and the second network operator.
